(19) United States
(12) Patent Application Publication
(10) Pub. No.: US 2006/0260972 A1
(43) Pub. Date: Nov. 23, 2006

(54) Expandable crate

(76) Inventor: James W. Ayres, Lincoln City, OR (US)

Correspondence Address: KLARQUIST SPARKMAN, LLP, 121 SW SALMON STREET, SUITE 1600, PORTLAND, OR, 97204, US

(21) Appl. No.: 11/418,805

(22) Filed: May 5, 2006

Related U.S. Application Data
(60) Provisional application No. 60/678,693, filed on May 6, 2005.

(51) Int. Cl. A01K 31/07; B65D 21/00

(52) U.S. Cl. 206/512; 119/453

(57) ABSTRACT

An expandable crate, such as an expandable animal crate, is disclosed that optionally is expandable and collapsible in multi-dimensions, most preferably in three dimensions, and has a usable interior space in the collapsed or expanded or in-between states. That is, the crate may be expanded or collapsed in one dimension, or two dimensions, or three dimensions, or even more than three dimensions. The size of the crate is adjustable by expansion or collapsing to provide a variety of sizes for use.

### CROSS REFERENCE TO RELATED APPLICATION

This application claims the benefit of the earlier filing date of U.S. provisional application, No. 60/678,693, which is incorporated herein by reference.

### FIELD

The present invention relates to a crate, particularly a crate that can be sized appropriately for various uses, such as an animal or storage crate.

### BACKGROUND

Description of the Prior Art

U.S. Pat. No. 5,653,194 states that animal crates are known in the prior art. More specifically, prior animal crates consist basically of familiar, expected and obvious structural configurations, notwithstanding the myriad of designs encompassed by the art. By way of example, U.S. Patent Des. No. 282,880 to Barati discloses an animal crate. U.S. Pat. No. 3,710,761 to Gregory discloses an animal shipping crate. U.S. Pat. No. 3,773,071 to Johannes discloses an animal crate for pick-up trucks. U.S. Pat. No. 3,962,994 to Petrucciani discloses a dog kennel module. U.S. Pat. No. 5,158,041 to Schmidtz discloses an animal holding crate.

U.S. Pat. No. 5,653,194 discloses an animal crate, “and in doing so provides an apparatus primarily developed for the purpose of allowing an animal to be transported therein when the animal crate is placed in an expanded operable configuration and further allowing ready transport when the animal crate is placed in a collapsed stowed configuration.”

U.S. Pat. No. 5,653,194 disclose a rectangular wire structure having six sides (or 4 sides, plus a top and a bottom) of fixed dimensions in length and width hingeably or wire clip coupled. The clips can be disconnected, allowing the sides to fold onto one side (the bottom) to produce a relatively flat rectangular structure of fixed dimensions in length and width that remain unchanged from the original length and width of the original bottom of the crate. Basically, this collapsible animal crate is either closed flat with no open interior space for an animal, or is open to full size. There is no further size adjustment capability that allows the crate to be adjusted to fit the size of the animal.

U.S. Pat. No. 5,335,618 discloses a collapsible animal enclosure of fixed height and width. The structure collapses from end-to-end by pushing the ends inwardly towards one another. This collapses a pliable material between the ends in an accordion-folded manner. U.S. Pat. No. 6,863,030 for a roll top pet carrier reviews pet carriers known in the art and describes a pet carrier that looks like a brief case or a suitcase when the curved sides roll into a bottom tray. The ends collapse on top of the bottom tray when not in use, and then expand into a semi-round top picnic basket shape when the ends are folded up and the sides (called “slidable doors”) are rolled out of the base to create a container for use. U.S. Pat. No. 6,863,030 discusses several “collapsible” pet carriers such as those in U.S. Pat. No. 6,394,036 B2, U.S. Pat. No. 5,950,568, U.S. Pat. No. 6,131,534, U.S. Pat. No. 6,345,591 B1, U.S. Pat. No. 5,669,331, U.S. Pat. No. 5,493,818, and U.S. Pat. No. 4,484,540.

But, animals grow and change size during their lifetime. Consider the following information excerpted as parts from the Humane Society of Delaware County, Ohio (http://www.delawarecobumanesoc.org/crate.htm):
WHAT IS A DOG CRATE? A dog crate is a rectangular enclosure with a top and a door, made in a variety of sizes proportioned to fit any type of dog. Constructed of wire, wood, metal, or molded fiberglass/plastic, its purpose is to provide guaranteed confinement for reasons of security, safety, housebreaking, protection of household goods, travel, illness, or just general control. The dog crate has long been accepted, trusted, and taken for granted by dog show exhibitors, obedience and field trial competitors, trainers, breeders, groomers, veterinarians, and anyone else who handles dogs regularly.
As The Dog Sees It: “I love having a room/house of my very own; it's my private special place, my ‘security blanket’ and the closed door really doesn't bother me.” If your dog could talk, this is how he might well express his reaction to using a crate! He would tell you that the crate helps to satisfy the “den instinct” inherited from his den-dwelling ancestors and relatives, and that he is not afraid or frustrated when closed in. He would further admit that he is actually much happier and more secure having his life controlled and structured by human beings—and would far rather be prevented from causing trouble than be punished for it later. SO . . . to you it may be a “cage”—to him, it's “home.”

What Kind of Crate is Best?
The most practical dog crate for use by the pet owner is the collapsible wire mesh type, available in a wide variety of sizes. Lightweight and easily handled, it allows total ventilation and permits the dog to see everything going on around him. A wooden, metal, or fiberglass/plastic airline crate will certainly also serve the purpose, but it restricts air and vision, is less convenient to handle and transport, and has a limited size selection.

What Size should a Crate Be?
A crate should always be large enough to permit any age dog to stretch out flat on his side without being cramped and to sit up without hitting his head on the top. While the adult size of a pure bred puppy is fairly easy to predict, that of a mixed breed must be estimated based on general breed/body type and puppy size at a given age. It is always better to use a crate a little too large than one a little too small. For a fully grown adult dog, measure the distance from tip of nose to base (not tip) of tail and use a crate close to, but not less than, this length. The height and width of most crates are properly proportioned to the length, including the convenient “slant-front” models designed to fit station wagons and hatchbacks.
For a puppy, measure as above, than add about 12″ for anticipated rapid growth. If a small crate is unavailable for temporary use, reduce the space of an adult size one (width can serve for length if the crate is large) with a reversed carton or a moveable/removable partition made of wire, wood, or masonite. Remember that a crate too large for a young puppy defeats its purpose of providing security and promoting bowel control, so its space should always be limited in the beginning except when being used as an over-all pen.
Increase the space inside the crate as the puppy grows so that he remains comfortable. If possible, borrow or rent a crate of adequate size.

Thus, a crate should be the “right” size that provides enough room for the animal to stretch out flat on his side or sit or stand without hitting his head, but the “right” size changes the puppy grows. The right size also is variable depending on breed or for different puppies or dogs of the same breed or even the same litter. In fact, this is true of all animals.

Further, it is the experience of this inventor that all animal crates available in fixed dimensions are not even fixed in the correct proportions for the animal. Consider the following two charts of dimensions for some available dog crates.

Dimensions
H 12″ × W 13″ × D 20″
H 22″ × W 22″ × D 30″
H 30″ × W 26″ × D 40″
H 40″ × W 36″ × D 50″

| Model# | Length | Width | Height | Dog Size |
|---|---|---|---|---|
| 1000 | 19″ | 13″ | 16″ | 15 lbs. |
| 2000 | 24″ | 17″ | 20″ | 25 lbs. |
| 3000 | 30″ | 19″ | 22″ | 40 lbs. |
| 4000 | 36″ | 23″ | 26″ | 70 lbs. |
| 5000 | 42″ | 28″ | 31.5″ | 90 lbs. |
| 6000 | 48″ | 30″ | 34″ | 110 lbs. |

The height of these fixed dimensions is not the same as the width. Yet experience and common sense make apparent that, for a dog to lie flat on its side in a stretched-out and often preferred position, the width must be about the same as the necessary height. And, an available molded plastic crate is wider in the middle than at the top or bottom. This results in a smaller width where the dog lays than is indicated by the largest outside dimensions, which are those “advertised” for crates. Thus, a molded plastic crate that is 36″×23″×26″ and the right height for a dog has an inside height of about 25″, an outside widest dimension of 23″, and an inside floor dimension of only about 17″. These dimensions do not meet the recommendation stated above that a “crate should always be large enough to permit any age dog to stretch out flat on his side without being cramped and to sit up without hitting his head on the top.”

Further, a crate of 36″×23″×26″ or larger is very difficult to place in the back seat of a car, even a midsize 4-door sedan, let alone a compact 2-door model. In some cases, carrying the crate in the car is sufficiently difficult to be considered either highly unlikely or even impossible. Still, it is most safe and secure for the dog and the passengers if the dog can stay in the crate while traveling in the car. In some cases the “slant-front” models may be desirable for one car in the family but a different configuration may be best for transport in a different car. When not in use, the available fixed-dimension, non-collapsible crates can be very bulky and space intensive, often are in the way in a home, occupy too much room in pet stores, are bulky and awkward during shipment, and may incur excessive shipping fees because of their size and/or shape.

The need for collapsible crates also has been ostensibly, but not practically, addressed by producing soft-sided crates that collapse around a fixed dimension frame and fold flat (http://www.doglogic.com/eezi.htm). These crates suffer from the disadvantages that dogs can bite through the fabric. The crates also are easy to tip over if attacked or charged by a dog or other animal from either inside or outside the crate. Further, soft crate dimensions are fixed during use. A general example of dimensions for a typical soft create is shown in the following table:

| Dimensions | Cost | Shipping |
|---|---|---|
| Small | 2.5 lbs | H 12″ × W 13″ × D 20″ |
| Medium | 5 lbs | H 22″ × W 22″ × D 30″ |
| Large | 8 lbs | H 30″ × W 26″ × D 40″ |
| Extra Large | 13 lbs | H 40″ × W 36″ × D 50″ |

These crates are not individually adjustable in size by expansion or collapsing in multiple dimensions to provide a variety of sizes for use.

In some cases it is desirable to limit mobility of an animal. This can be advantageous during recovery from an injury or for other reasons. As a result, it is highly desirable to use a crate that can be readily collapsed to fit snugly enough to restrain mobility, often in more than one dimension.

It has been recognized that a crate should be adjustable for a puppy as the puppy grows. “Puppy panels” are available for some wire crates as seen at: http://www.precisionpet.com/productPage2.asp?pid=219. Puppy panels are inserted into a fixed-dimension crate that is too large for the puppy in order to make the interior smaller in one dimension only. The interior remains too large in two dimensions. The outside dimensions of the crate are fixed and thus the crate suffers from nearly all of the problems associated with all fixed-dimension crates.

### SUMMARY

None of the patents discussed in the Background concerns a crate, such as an animal crate, that provides a usable space in a stabilized, partially collapsed or collapsed configuration, none is expandable in more than one dimension, and none is collapsible and expandable to provide a well-designed fit for an animal or person of different sizes.

Therefore, it can be appreciated that a need exists for a new and improved crate that: (1) can be expanded or collapsed in multi-dimensions; (2) can be secured in a partially or fully expanded or collapsed position(s); (3) provides a space for an animal or human when in the partially or fully collapsed configuration or the expanded configuration; (4) is easily collapsed for storage or loading through spaces that are relatively small compared to the expanded crate size followed by ready expansion as desired; and/or (5) is useful for transporting an animal or objects. The present invention satisfies these needs.

In view of the foregoing disadvantages inherent in known animal crates, certain disclosed embodiments provide an improved portable animal crate expandable in multi-dimensions. Embodiments of a method for producing and for using disclosed crates are disclosed.

Certain embodiments of the crate are useful as an animal crate that has expandable length, width, and height dimensions. Disclosed crates typically have both a collapsed configuration and an expanded configuration, and may have plural expanded or collapsed configurations. Both the collapsed configuration and the expanded configuration may define a usable interior space. The amount by which the crate can be expanded is variable, but in certain embodiments disclosed crates can be expanded by at least 1.8 times its' original dimension in at least one, or two or more in any combination, of the dimensions of length, width, and height.

Animal crates can comprise multiple panels, typically but not necessarily, panels having fixed dimensions. The multiple panels are assembled together to produce an animal crate expandable in multi-dimensions, such as a crate comprising at least 5 sides, and typically 6 or more sides, expandable and collapsible in at least two dimensions, and which defines a usable interior space in an assembled collapsed configuration. Additional exemplary animal crates may be expandable in at least two of length, width, and height.

Disclosed crates may include at least one, and potentially plural, openable or removable sides. This features facilitates ingress/egress to the crate.

Disclosed crates have a multitude of utilities, and are not solely useful as animal crates. Instead, animal crates are one embodiment described in substantial detail to exemplify additional utilities. Accordingly, some additional non-limiting utilities include camping sleepers, tool sheds, bullet-proof or bullet resistant structures, hunting blinds, stacking storage modules, closet organizers, etc.

A particular disclosed embodiment of a crate according to the present invention defines a collapsible/expandable structure. Both the collapsed and expanded structures enclose usable interior space definable by dimensions of length, width, and height. The structure typically comprises a top roof and a bottom floor, each expandable/collapsible in at least two dimensions, front and rear walls each expandable/collapsible in at least two dimensions, at least two side walls, each expandable/collapsible in at least two dimensions, the side walls being attached to the roof and to the bottom and to the front and rear walls such that the structure is collapsible/expandable in at least three dimensions. Each of the walls, roof or floor may be openable, and at least partially, if not fully, removable, as desired.

Moreover, one or more doors may be included in the structure. In certain embodiments, the door may be expandable/collapsible in at least two dimensions. The crate door may have at least one panel of fixed dimensions in length, height, and width, where the fixed dimensions for each of length, height and width dimensions can be the same or different. Alternatively, the door may comprise plural panels that when assembled define the door.

In certain embodiments, the sidewalls and front and rear walls may be pivotally attached to the floor, roof, or both. This feature facilitates folding the crate into a configuration that does not have a usable interior space, such as for transportation without having an animal or object housed in the crate.

Panels used to assemble crates can be assembled to form components of crates. For example, it will be apparent that disclosed crates can be expanded or collapsed to define variably-dimensioned usable space. This space also can be further defined using dividers. For example, certain crates may include a panel of fixed dimension in length, height, and width. The panel can be used as a divider alone, or can be constructed to be assembled with other panels, typically but not necessarily, of fixed dimension in length, width, and height to produce a vertical or horizontal divider in the crate. As another example, crate components can be assembled using one or more panels, such as using 3 panels that, when assembled, define a crate corner. Multiple corners, typically 8 corners, are joined to define a crate.

The panels may be coupled together using a variety of connectors. For example, certain embodiments include at least one wall having a button and slide connector. Other exemplary panel connectors include male-female hinges, push rods, twist rods, telescoping rods, spring loaded rods, slide guide clips, locking clips, etc.

Panels may be substantially solid. Other panel embodiments may include or define openings for ingress or egress. Still other panels may have at least one aperture, typically plural such apertures, such as might be useful for air or sight. Still other embodiments may have a substantially smooth surface, may include textured surfaces, such as may facilitate handling or heat transfer, may have aesthetic features formed therein or on, and any and all combinations thereof.

Assembled crates can include optional features that facilitate use. For example, a crate might include a handle, rollers, or both.

A particular disclosed embodiment of the present invention is directed to a crate for housing at least one individual, and potentially plural individuals. Such crates have a variety of purposes, including camping or military shelters, hunting blinds, etc. These crates typically comprise plural panels that are movable in multi-dimensions and sizeable in an assembled state for receiving at least one human. These crates preferably, but not necessarily, are portable, and perhaps portable by a single individual.

Crate and panel components can be made from any suitable material and by any suitable technique. For example, certain embodiments of disclosed crates comprise at least one component made by extrusion molding, pressure molding, or both.

It will be apparent that disclosed crates may be assembled using panels. As a result, the present application also concerns panels useful for forming such crates, or other structures. One embodiment of a disclosed panel has fixed dimensions in length, height, and width and is constructed to be assembled with other panels of fixed dimension in length, width, and height to produce a crate expandable in multi-dimensions.

### BRIEF DESCRIPTION OF THE DRAWINGS

FIG. 1 is a line drawing of one embodiment of a crate according to the present invention illustrating how the embodiment can expand and collapse in length, width, height (in all figures the arrows represent directions of expansion and/or collapsing unless otherwise labeled).

FIG. 2 is a perspective view illustrating an embodiment of a disclosed crate comprising 4 sections 202, 204, 206, 208, each containing three sides to create a corner. The 4 corners thus created can be assembled together to form the crate. Section 240 can be substituted for section 202, and section 250 can be substituted for section 208 to create an opening in the assembled sections if desired. This assembled group can be combined with other assembled components as desired. For example, simply by flipping over each component illustrated in FIG. 2, 4 additional crate sections are created, each containing three sides to define a corner. Four corners can be assembled together to form a crate structure having a top and sides.

FIG. 3 is a perspective view illustrating one embodiment of a crate comprising a door or closure expandable in at least two dimensions further comprising panels of fixed dimensions in length, height and width assembled with other panels of fixed dimensions in length, height and width.

FIG. 4 is a schematic plan view illustrating one possible door or closure configuration comprising spring-loaded telescoping rods that both hold the door in place and act as hinges to allow opening in either the left or right direction.

FIG. 5 is a schematic plan view illustrating plural panels of one embodiment having a button and slide configuration, such that following assembly, the panels create a section that is expandable or collapsible in two dimensions, where the section is assembled with other sections to produce a crate that is expandable and securable in multi-dimensions.

FIG. 6 is a perspective view illustrating assembly of one panel embodiment comprising a button and slide configuration.

FIG. 7 is a perspective view illustrating one panel embodiment having button and slide connectors.

FIG. 8 is a perspective view illustrating a dissembled corner piece designed for easy assembly and joining onto corners of panels such as those shown in FIG. 5.

FIG. 9 is a perspective view illustrating an alternative utility for one disclosed embodiment for use as an expandable sleeping crate.

FIG. 10 is a perspective view illustrating how the crate of FIG. 9 is expandable in multi-dimensions.

FIG. 11 is a perspective view of one embodiment of a panel having female and male hinge snap connectors allowing assembly of three panels to form a corner that can be further assembled with other corners to produce a crate expandable in multi-dimensions.

FIG. 12 is a perspective view of one embodiment of a panel having female and male hinge snap connectors allowing assembly of three panels to form a corner that can be further assembled with other corners to produce a crate expandable in multi-dimensions.

FIG. 13 is a perspective view of one embodiment of a panel having female and male hinge snap connectors allowing assembly of three panels to form a corner that can be further assembled with other corners to produce a crate expandable in multi-dimensions.

FIG. 14 is a perspective view of one embodiment of a panel having female and male hinge snap connectors allowing assembly of three panels to form a corner that can be further assembled with other corners to produce a crate expandable in multi-dimensions.

FIG. 15 is a perspective view of one embodiment of a crate according to the present invention following assembly using disclosed panels.

FIG. 16 is a perspective view illustrating one embodiment of a corner assembled using three panels and hinge snaps.

FIG. 17 is a partial perspective view of a clip that snaps onto a hinge and overlaps adjacent sliding panels useful for making one embodiment of a multi-dimensional expandable crate.

FIG. 18 is a partial perspective view illustrating one embodiment of a clip used to stabilize movement in a multi-dimensional expandable crate.

FIG. 19 is perspective view illustrating one embodiment of an assembled crate according to the present invention.

FIG. 20 is a perspective view illustrating a panel having a slide bar.

FIGS. 21A and B are cross sectional schematic views illustrating the panel and slide of FIG. 20.

FIG. 22 is a perspective cross sectional view illustrating two panels fixed in relative position using a slide bar.

### DETAILED DESCRIPTION

It should be recognized that the disclosed and illustrated embodiments are only exemplary of the invention and should not be taken as limiting the scope of the invention.

### I. Introduction

Unless otherwise explained, all technical and other terms used herein have the same meaning as commonly understood by one of ordinary skill in the art to which this invention pertains. The singular terms “a,” “an,” and “the” include plural referents unless context clearly indicates otherwise. Although methods and materials similar or equivalent to those described herein can be used in the practice or testing of the present invention, suitable methods and materials are described below. The described materials, methods, and examples are illustrative only and are not intended to be limiting.

### II. Terms

Term definitions are provided solely for the benefit of the reader, and should not be construed to limit the defined terms to any specific examples provided, or to be definitions that would be narrower than accepted by persons of ordinary skill in the art.

“Multi-dimensions” means at least two of length, width, and height dimensions, such as, length and width or height and width, for just two possible examples. In some embodiments, multi-dimensions means length, width, and height. In some embodiments, “multi-dimensions” means that at least one of the at least two dimensions of length, width and height is expandable to a different extent at one point in a crate or structure than at another point. That is, height may be expandable to a different extent at one end of the crate or structure than at the other end, for one example only. In certain embodiments multi-dimensional expansion can occur in more than one of the at least two dimensions. These concepts are illustrated by the accompanying figures.

“Expandable” means that the crate can be expanded or contracted such that the expansion increases the dimension in the direction of expansion, typically by at least 10% from the fully contracted state. Contraction and expansion are movements that take place in opposition to each other and the concept is readily understood in the general sense by analogy to the movement of a telescoping fishing pole that can be expanded from the contracted state to be longer, and then also can be contracted from the expanded state to be shorter. The terms contract and collapse or contractible and collapsible are all interchangeable in terms of multi-dimensional expansion.

“Side” refers to any of the sides and also, unless context indicates otherwise, may refer to a top, bottom or end. In certain descriptions, the terms “top, “bottom” and “end” also may be used according to their common and ordinary meaning. A hard side is a relative term when compared to a soft side and the terms are readily recognized and have their ordinary and customary meanings. As some non-limiting examples, a hard side might be made from a rigid or semi-rigid material. Examples of such material include polymeric materials, such as a material commonly used in molded plastic dog houses; metal materials or metal alloys, such as stainless steel and aluminum; wood or word composites; or other material suitable to form rigid or semi-rigid panels. Non-limiting examples of soft sides include materials broadly classified as fabrics, both man made and natural, and certain polymeric materials, and includes all such materials that are or can be folded, wrinkled, sewn or have other common characteristics of fabrics. Metal mesh and other materials, for example may be considered a soft side in some cases and a hard side in other cases depending on the comparison or criterion being used.

It will be readily apparent from the text and examples that the invention disclosed herein as a portable animal crate expandable in multi-dimensions also has many other new and novel uses that are previously unrecognized, some of which are disclosed herein for the multi-dimensional expandable structure of this invention, and will take on names as appropriate for the use of the multi-dimensional expandable structure. Thus, the term animal crate is intended to include all such new and novel structures, uses and appropriate names.

### III. Composition/Structure

Generally, the invention is composed of any materials appropriate to meet the purpose of the invention. Examples of such materials include, but are not limited to, polymeric materials, such as plastics, wood, wood composites, metals, alloys, including stainless steel and aluminum, fabrics, insulating materials, such as fiberglass, and any and all combinations of such materials. These terms are intended to have their broadest meaning possible and not to be limited to a specific meaning but to include all pure or mixtures of materials that generally can be considered to be of a particular type or appropriate to meet the purpose of the invention. Any reference to wood means all woods and mixtures of woods, including particle board, plywood, wood-plastic composites, etc., and within any category of materials is included all composites or mixtures of materials of either like or unlike materials so long as appropriate to meet one or more purposes of disclosed embodiments of the present invention.

These materials also can be used in various configurations into which the materials may be formed. For example, suitable materials may be configured as panels, fibers, wires, sheets, etc., for some specific examples. Thermal insulating materials, including structural foam materials and outer film protective layers, such as those disclosed in U.S. Pat. No. 5,950,568, incorporated herein by reference, may be included when desirable. Certain disclosed embodiments include hard-walled, multi-dimensional expansion crates. Certain disclosed embodiments also can be implemented as soft-sided, multi-dimensional expandable crates.

Disclosed crates of the present invention, such as animal crates expandable in multi-dimensions, may have any features of known crates including, but not limited to: thermal insulation; heaters; coolers; fans; ventilation openings; water or food dish(es); at least one wall, such as a floor, that is substantially water tight (does not leak to a degree that renders the crate unusable, and in a preferred example substantially leak proof); flexible or foldable fabric or plastic rugs or curtains on any side; an insert tray; a wheel or wheels; storage pockets, such as for holding a dog leash, food or other items; tie ring(s), such as to attach a leash; rollers for easy sliding or rolling; carrying handle(s); at least one and potentially multiple doors, such as, for example, a door at one end and then either top, or side, or other end or any combination thereof; an open or openable top, such that an animal may or may not have the roof fully closed or open; no bottom, so that the floor of a room or vehicle may provide the floor; doors that may open both left and right, and/or up and down; easy to clean materials; materials that are easily molded or shaped; transparent or semi-transparent materials, or viewing apertures, to allow visibility both out and in; rounded corners and edges without sharp points; separable components, such that either ½ (top or bottom, or in some cases, left-end or right-end) can be used as a crate or a tub to wash the animal; etc.

Typically, crates expandable in multi-dimensions of this invention may have a collapsed configuration or configurations and an expanded configuration or configurations. Both collapsed and expanded configurations may have a usable interior space characterized by length, width, and height dimensions. That is, the interior can be used for storage of desired items or to house an animal of appropriate size even when the structure is in a collapsed state. The crate also may have a fully collapsed configuration that is most useful for transporting the crate without housing any objects or animals. A usable interior space in the collapsed configuration is novel when compared to known collapsible animal crates in which sides of fixed dimensions that are not individually expandable or collapsible can be folded on top of each other to form a relatively flat structure with each side retaining its' individual fixed length and width. Known crates do not provide any usable interior space when collapsed. In some disclosed embodiments of the present invention, the collapsed structure may be even further collapsed by folding or disassembling the sides (before or after collapsing) to stack with the top and bottom. But a unique feature of some disclosed embodiments is that, after the structure is unfolded or un-stacked and assembled to form a crate with a usable interior space characterized by length, width, and height dimensions, the crate still may be in a collapsed configuration, although obviously less collapsed than when in the completely folded configuration described above. These embodiments can be stabilized in this partially expanded configuration for use. The crate then may be expanded further as desired to increase the useable interior space and can be stabilized in multi-dimensions for use in different sizes.

A person of ordinary skill in the art will appreciate that the length, width, and height dimensions for a generally usable interior space and a generally overall exterior size will depend on multiple factors, including intended use. Length, width, and height dimensions further may be different for different portions of the crate depending on various factors, such as the materials used and the type of structure involved, including the number of components involved, type of assembly, and the degree of overlap of some component parts, for example.

Disclosed crate components may themselves be expandable, or may be coupled together to form a crate that is itself expandable in multi-dimensions. For example, and without limitation, a panel, such as a square or rectangular panel, may consist of a first portion and a second portion that are movable relative to one another to create a panel that can be expanded in at least one, and possibly plural, dimensions. Alternatively, individual components, such as a single panel, may be of fixed dimensions that, when coupled together, such as by using a button and slide configuration, form a crate that is expandable in multi-dimensions.

One embodiment of a disclosed animal crate comprises multiple panels of fixed dimensions. These multiple panels of fixed dimensions may be assembled together to produce an animal crate expandable in multi-dimensions. The panels may be of the same size or different sizes within a single structure.

One disclosed embodiment comprises a panel of a fixed dimension in length, height, and width constructed to be assembled with other panels of a fixed dimension in length, width, and height to produce an animal crate expandable in multi-dimensions. This embodiment makes assembly possible at a desired site, such as by a homemaker or person generally unskilled in dog crate assembly, at home as one non-limiting example.

Assembly of the panels optionally may include using edge or corner pieces as are illustrated in certain drawings. The edge or corner pieces may be effectively coupled together by any suitable technique including, but not limited to, adhesives, hinges, fasteners, such as bolts, screws, clips, etc., interlocking designs, and combinations thereof. Of course, sides may be assembled and attached by any appropriate methods. Moreover, components of crates also can be made by any suitable method, such as extrusion molding, pressure molding, and combinations of suitable methods.

The invention is illustrated by the following non-limiting examples.

### EXAMPLE 1

This example concerns methods, figures, and an example for making multi-dimensional expansion crates. The methods, figures and an example are used only to illustrate further the concept of an animal crate that is optionally expandable and collapsible in multi-dimensions. The degree of expansion from the collapsed state typically is at least 10%, and even more typically is at least 1.8 times the original, in at least one of the dimensions of length, width, or height. It will be apparent that modifications can be made readily in the various components such as, for non-limiting examples, panel design, methods of locking or guiding panels, dimensions, creating or omitting openings in panels for use as windows, doors, ventilation or handles, shapes, and connecting hardware or items. Such modifications are considered to be within the scope of this disclosure of a crate that optionally is expandable and collapsible in multi-dimensions.

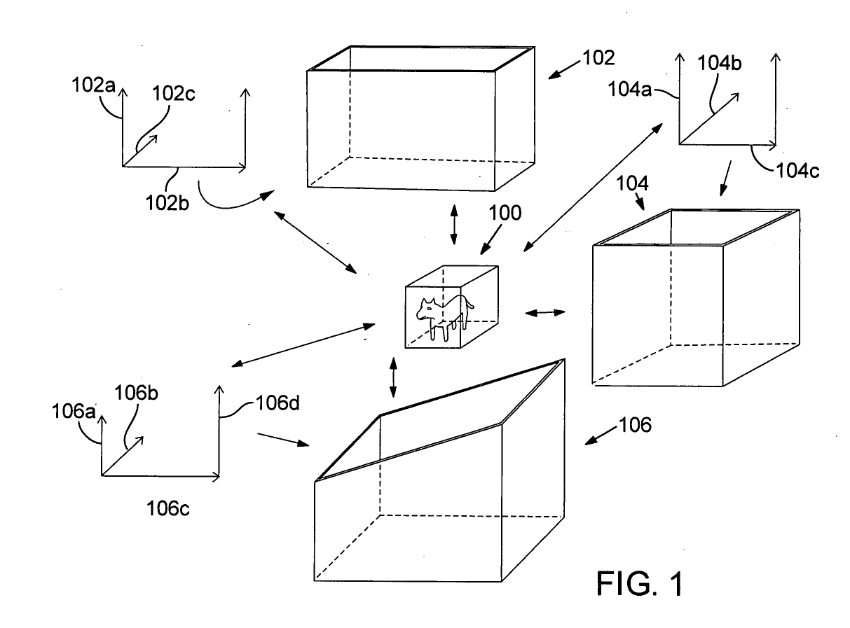

Turning now to the figures, FIG. 1 shows an embodiment 100 of a crate that is expandable in multi-dimensions. The illustrated crate 100 is substantially square or rectangular. However, other geometric shapes also are within the scope of the present invention including, without limitation, triangular, pentagonal, hexagonal, circular, spherical, dome shaped, parallelepipeds, trapezoidal, trapezoidal having at least one right angle, rhomboid, complex shapes comprising one or more of these simpler shapes, and the like, are included. FIG. 1 shows the expansion of the illustrated embodiment 100 into three different sizes and shapes 102, 104 and 106 as a result of variable expansion in the dimensions of length, width and height. Multi-dimensional expansion is best demonstrated with reference to crate 106 having a slant front or end. Crate 100 can be expanded to form crate 102 by expansion along axes 102a, 102b, 102c, and any combination of such axes. It will be appreciated that the usable space defined by crate 102 is greater than that provided by crate 100. As a result, for the exemplary animal crate utility, a pet of a first size can be housed in crate 100 and a pet of a second larger size can be housed in crate 102. Similarly, crate 104 can be formed by expansion along axes 104a, 104b, 104c, and any combination of such axes. Crate 106 can be formed by expansion along axes 106a, 106b, 106c, 106d, and any combination of such axes. It also will be appreciated that a crate, such as 100, 104 or 106 that is fully expanded also can be collapsed, partially or fully, along any such axes too.

Crate 100 has usable interior space even in its collapsed state relative to crate 102. Crate 100 may be further collapsed to a fully collapsed state for transporting. Openings can be included in one or more sides to allow for example, animal ingress or egress. The size of the portable animal crate expandable in multi-dimensions as disclosed herein is not limited to a size appropriate for a single animal. It may be large enough for multiple animals or may even be larger than is typically considered appropriate for any particular animal and may have a different common name based on the intended use.

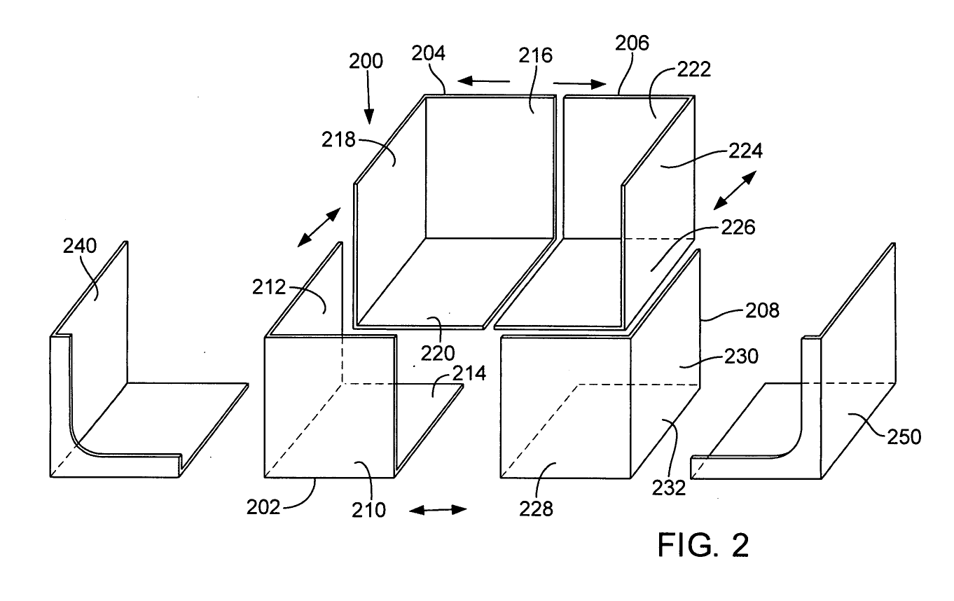

FIG. 2 illustrates an embodiment 200 having 4 sections 202, 204, 206 and 208. Each section contains three walls, 210, 212, 214 for section 202; 216, 218, 220, for section 204; 222, 224, 226 for section 206; and 228, 230 and 232 for section 208. When assembled, sections 202, 204, 206 and 208 define corner portions of a crate. The 4 corners thus created can be assembled together to form the bottom and sides of a crate. Section 240 can be substituted for section 202, and section 250 can be substituted for section 208, to create an opening in the assembled sections if desired.

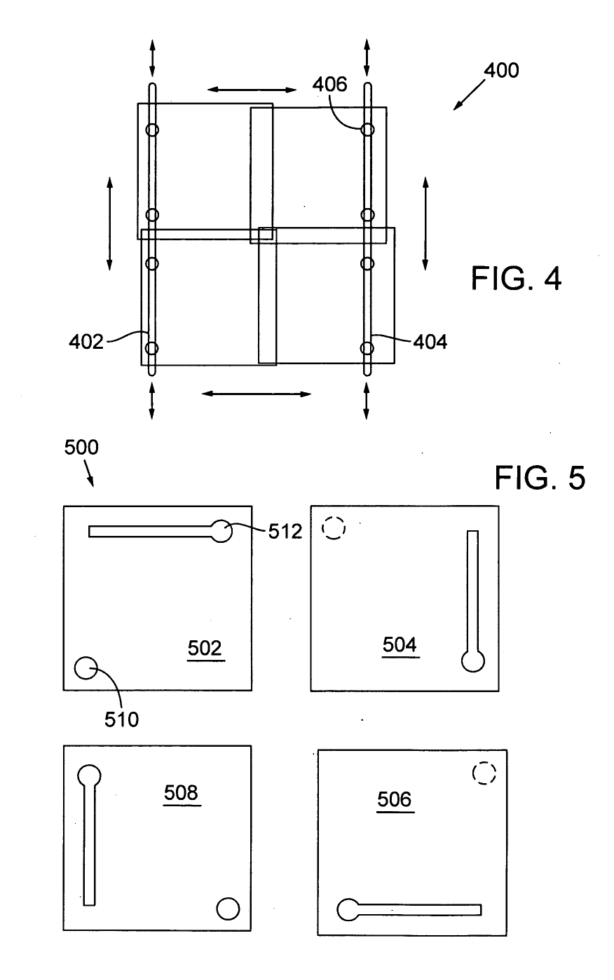

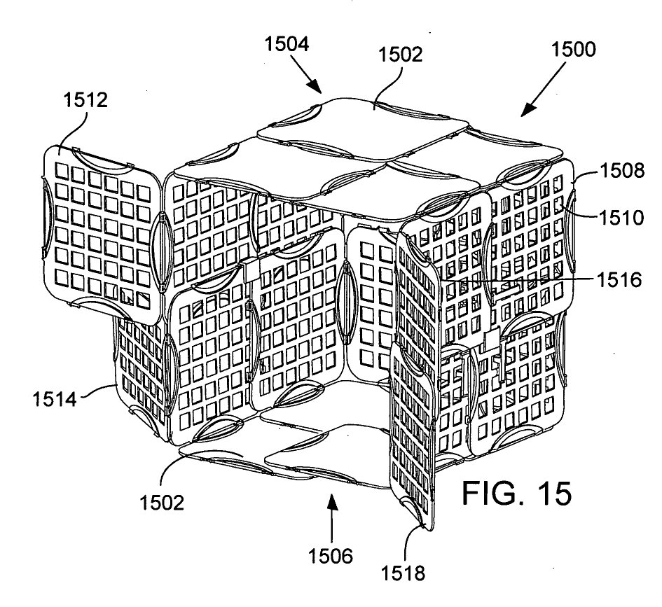

The components illustrated in FIG. 2, if flipped over, define an additional embodiment having 4 sections, each section containing three walls to create a corner. When assembled, the walls define corners. The 4 corners thus created by sections can be assembled together to form the top and part of the sides of one disclosed embodiment. These assembled groups then can be combined with other assembled sections, such as the assembled sections of FIG. 2. With appropriate panels, a multi-dimensional expandable structure is created comprising an opening for egress and ingress, such as by an animal or human. Moreover, if desired, the opening can be fitted with a door, such as is shown in FIGS. 4 and 15. The method by which the illustrated panels are interlocked is not shown in these drawings.

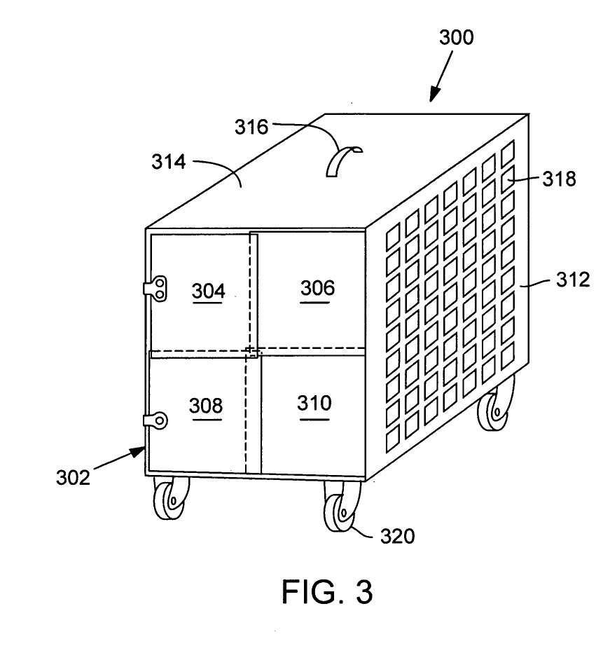

FIG. 3 represents one possible embodiment 300 having a door or closure 302. Door or closure 302 is expandable. The illustrated embodiment of door 302 is expandable in at least two dimensions. The illustrated embodiment comprises panels 304, 306, 308 and 310, typically but not necessarily of fixed length, height and width dimensions that are assembled to define door or closure 302. Door 302 can be coupled with other component(s) or panel(s), again typically but not necessarily of fixed length, height and width dimensions, such as panels 312 and 314, to define crate 300. Crate 300 also illustrates a carrying handle 316. Embodiment 300 also includes rollers 320. It will be understood that certain embodiments might include a handle 316, but not rollers 320, or rollers 320 but not handle 316. Moreover, panel 312 illustrates using perforations, such as plural perforations 318. One reason for including one or more perforations 318 is for as a ventilation port or ports.

FIG. 4 illustrates one possible door or closure configuration 400. One embodiment of configuration 400 includes telescoping rods 402, 404, and such rods may be spring-loaded telescoping rods. Rods 402, 404 extend through rod-receiving apertures 406. Rods 402, 404 both hold the door in place and act as hinges to allow opening in either the left or right direction. FIG. 4 shows panels of fixed dimension in length, height, and width constructed to be assembled with other panels of fixed dimension in length, width, and height to produce a door or closure for an opening in a crate expandable in multi-dimensions. It is not necessary that all panels of fixed dimension in length, height, and width of assembly are equal in dimension, and not necessary that the dimensions of length, height, and width are equal to each other.

FIG. 5 illustrates an embodiment 500 comprising panels 502, 504, 506 and 508. Embodiment 500 employs a button 510 and slide configuration 512 for assembly and sizing. Thus, following assembly of panels 502, 504, 506 and 508 a section is created that is expandable or collapsible in two dimensions. These panels 502, 504, 506 and/or 508 can be assembled to form useful structures, such as a tray that can be inserted to divide a crate into two different usable spaces, or as a floor. Button 510 may be fixed in position to secure the structure in a desired state of expansion. For example, button 510 may include a screw-knob that can be tightened to fix or secure the structure as desired. A person of ordinary skill will appreciate that alternative mechanisms may be employed to form a structure having secured dimensions, such as cam-locks, wing-nuts, twist-lock rods, variegated “tooth” locks, clips, straps, and any other appropriate fixing or stabilization method. Panels 502, 504, 506 and 508 may have fixed length, height, and width dimensions designed to be assembled with other panels of fixed dimension in length, width, and height to produce an animal crate expandable in multi-dimensions. It is not required that the fixed dimension in length, height, and width be equal to each other. It also is not required that panels 502, 504, 506 and 508 be of identical dimensions to each other so long as they assemble to produce the desired structure. A result can be an animal crate comprising multiple panels of fixed dimensions that define an assembled crate expandable in multi-dimensions. Without a floor or in a pentagonal shape the result can be a crate comprising at least 5 sides that is expandable in multi-dimensions.

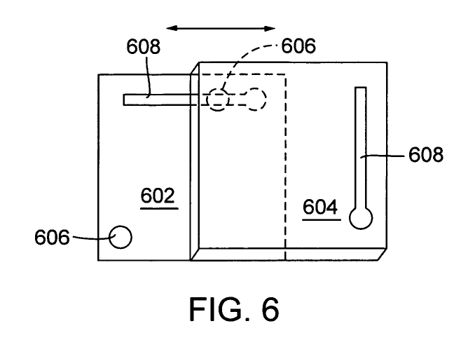

FIG. 6 shows panels 602, 604, having button 606 and slide 608, being assembled into an expandable/collapsible section.

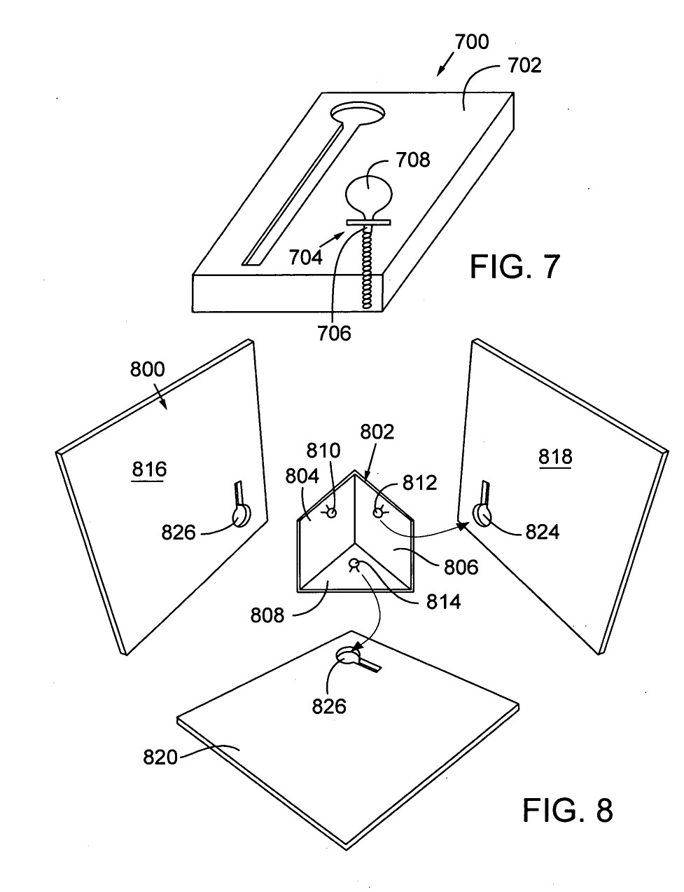

FIG. 7 illustrates an embodiment 700 of a panel 702 having a button design 704 comprising a neck 706 that is appropriately shaped, such as rectangular, and appropriately sized to fit in the slot of another panel when the button is passed through the opening at the end of the slot. The illustrated button 704 also comprises a screw-knob 708 that can be turned to raise or lower the knob, thus allowing the knob to be tightened at any desired point during expansion or collapsing of connected panels, thereby fixing or stabilizing the panels at the desired extent of expansion. Button 704 also can be spring biased into position, as illustrated. Neck 706 of the buttons 704 in this embodiment are of appropriate length to allow stacking of the collapsed panels. It will be apparent that in many cases the panels are made of thin sheets of material, such as plastic as only one example. As a result, stacking and overlapping during collapsing of panels results in a collapsed plural panels that are not very thick themselves, although obviously at least 4 times as thick as the individual panels for the configuration shown. In other cases, the panels may be made of thick materials, with no predetermined limit on size except that which is appropriate for the final product. Thus, the neck 706 of the button 704 will be of appropriate length depending on the materials involved.

One way to describe certain disclosed embodiments is as a collapsible/expandable structure comprising a top wall (roof) and bottom wall (floor) that are each expandable/collapsible in at least two dimensions; front and rear walls, each being expandable/collapsible in at least two dimensions; at least two side walls, each being expandable/collapsible in at least two dimensions; the side walls being capable of being effectively coupled to the roof and to the bottom and to the front and rear walls such that the structure is collapsible/expandable in at least three dimensions. These structures enclose a usable interior space definable by dimensions of length, width, and height in both the collapsed and expanded configurations, with the understanding also that the walls, top, and/or bottom, can be effectively disassembled from each other to provide a more readily portable structure. The structure can be fitted with openings for ingress and egress or loading of contents and also fitted with a suitable door or closure. The door or closure may be expandable/collapsible in at least two dimensions. The sidewalls and front and rear walls may be pivotally attached to the floor or roof or both to facilitate folding of said walls, roof, and floor into a configuration that does not contain a usable interior space, thus allowing for even further decrease in size beyond the collapsing into the smallest size that still contains a usable interior space.

Alternative methods of guiding and/or fixing plural panels in position may be employed. Examples of such alternative methods include, but are not limited to, tongue and groove design, dado and ridge design, off-set rollers, such as are used for cabinets, overlapping and interlocking edges, “fingers” or slides, pulley or lever and channels, any and all appropriate combinations thereof, and any other design that is appropriate for the use.

FIG. 8 illustrates a corner piece 802 comprising walls 804, 806, 808 designed for easy assembly and joining onto corners of panels. Corner piece 802 also may include buttons 810, 812 and 814. Any suitable corner piece, such as telescoping, or with channels or ridges, or any other appropriate design, may be used and may be connected with panels by interlocking, such as by snapping into place or by hinges or glue or screws and other means. Panels 816, 818 and 820 also might be coupled to corner unit 802 using slots 822, 824 and 826, respectively.

### EXAMPLE 2

It will be readily apparent that, while much discussion has involved a portable crate or structure that is expandable in multi-dimensions typically useful as an animal crate, disclosed embodiments also have many other uses. Thus, “crate” is intended to include all such structures, and their uses.

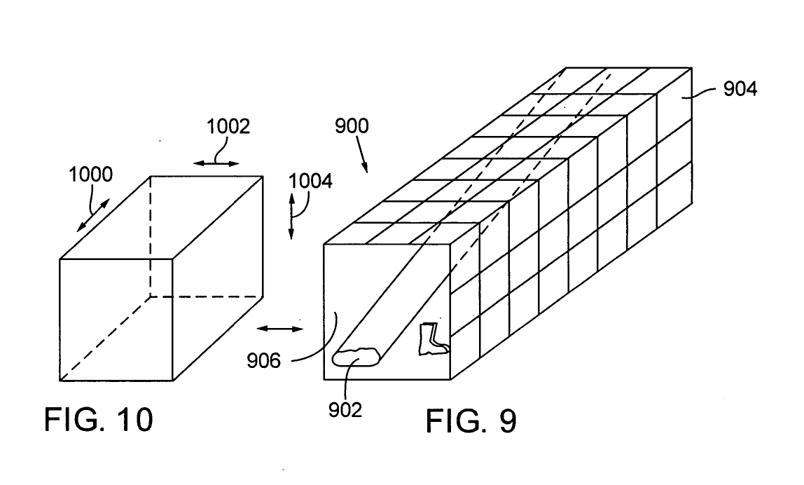

For one non-limiting example, FIG. 9 illustrates a multi-dimensional expandable crate 900. Crate 900 can be readily used as a container for housing a sleeping bag 902 when collapsed or partially collapsed. Crate 900 also can be expanded to provide a hard-sided and/or soft-sided container for protection from the elements, such as wind, sand, direct sun, rain or snow.

Crate 900 has 4 walls that can be formed using plural individual panels 904 interconnected as described above. Crate 900 can have one or more open ends 906 for entering and exiting the crate. While not illustrated, it will be appreciated that an end 906 also might include a door, such as described herein. FIG. 10 illustrates that the crate can be expanded and collapsed along axes 1000, 1002 and/or 1004 to size the crate as desired.

Innumerable names might be used to describe structure 900 other than crate. It could, for example, be referred to in a hard-side embodiment as a “turtle shell sleeping bag box”.

Another embodiment for disclosed multi-dimensional expandable structure can be useful as a “tool shed,” and may be an appropriate length, width, and height for use as a tool shed, such as about 8′ wide and 12′ long and 8′ high in the most expanded position and about 2′×2′×2′ when fully collapsed. It will be appreciated that other dimensions also are useful, depending on the size of the panels involved, number of panels, and the materials used for the structure, to name only some of the parts that effect dimensions.

While plastic or fiberglass materials are preferred for some such embodiments, other embodiments may be constructed of fabric, wood, metals, such as aluminum or steel, any other appropriate materials, and combinations thereof. In some cases, the multi-dimensional expandable structure may be constructed of a “bullet-proof” or “projectile resistant” material or any material appropriate for the conditions involved in a military operation. Thus, the panels may have appropriate colors and/or markings suitable for military applications, such as green camouflage. The structure can readily be transported in the collapsed state and quickly expanded in multi-dimensions, (usually height, width, and length) at the desired site to be an appropriate size for one, two, three or more soldiers, for one non-limiting example. Appropriate supplies or weapons may be enclosed in the interior space characterized by length, width, and height dimensions of the collapsed structure which acts as a container during transport. This concept is made generally clear in the figures discussed above.

Another embodiment for disclosed multi-dimensional expandable structures include hunting blinds, such as are used by duck hunters or deer hunters.

Another embodiment for disclosed multi-dimensional expandable structures include porta-potty structures. These structures are moved from site-to-site and can be most easily moved in the collapsed configuration.

Another embodiment for disclosed multi-dimensional expandable structures include containers for a variety of items including, but not limited, to toys, reusable shipping crates or boxes, closet organizers, play houses for children, suitcase, coffin, motorcycle cover, and green house. It is appropriate to repeat that the materials used to construct the multi-dimensional expanding crate may be any material that is appropriate for the intended use and include, without limitation, the materials commonly used for each of the recognized names that would be applied to a particular embodiment of the invention based on the intended use. further non-limiting illustrations include using cardboard for making a multi-dimensional expanding crate, such as might be useful as a shipping or storage box or for small animals; plastic may be used for a multi-dimensional expanding crate used as a playhouse; fabric may be used for a multi-dimensional expanding crate used as a suitcase; steel or metal alloys or Kevlar may be used for a multi-dimensional expanding crate used as a portable bunker; and wood may be used for a multi-dimensional expanding crate used as a tool shed. Of course, each embodiment may consist of a combination of appropriate materials and different parts of the multi-dimensional expanding crate may consist of different appropriate materials.

### EXAMPLE 3

This example further illustrates methods, figures, and examples of panels and assembly to make a crate that is expandable in multi-dimensions. The panels may be assembled into useful structures, including disclosed crate embodiments, that typically are expandable in the dimensions of length, width, and/or height to provide a usable interior space characterized by dimensions of length, width, and height in the collapsed configuration of the assembled crate. The crate typically can be further expanded independently in any one or all three of the dimensions of length, height, or width. Each individual panel in this example typically has fixed dimensions in length, height, and width. Plural panels are assembled together to produce the multi-dimensional expandable crate. However, it also will be appreciated that individual panels also might be sizable too, and might be expandable or collapsible in one or more dimension. These and other aspects of the invention are illustrated in the figures and text.

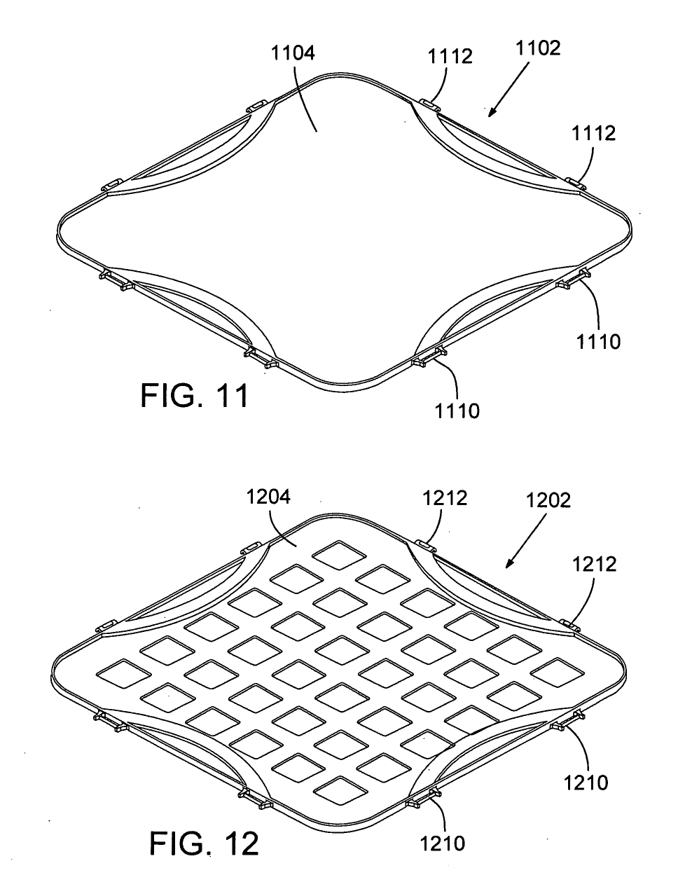

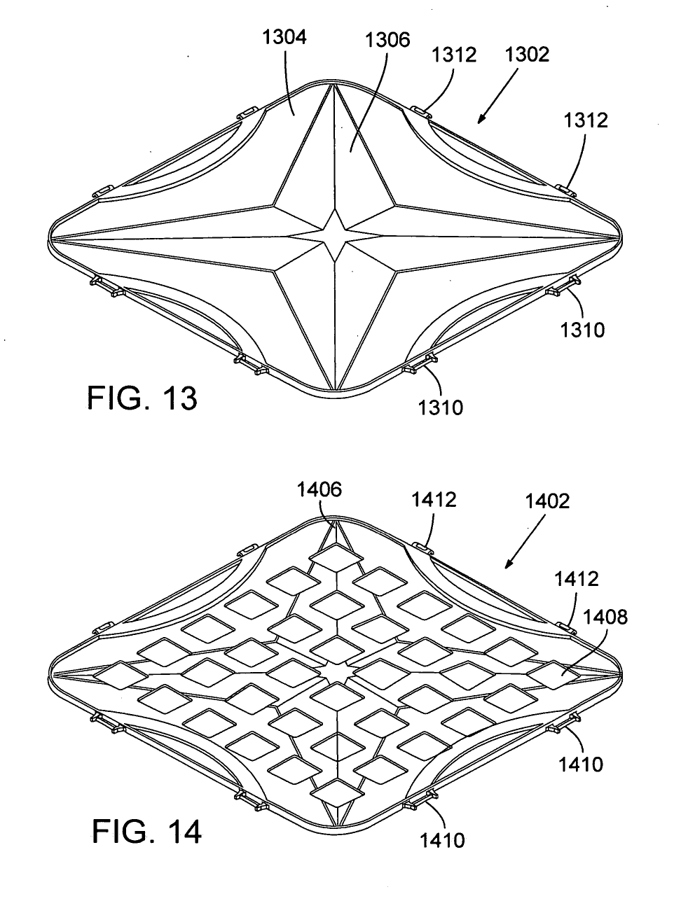

FIGS. 11-14 illustrate panels such as panels 1102, 1202, 1302 and 1402. Panels illustrated by FIGS. 11-14 are substantially similar. However, FIGS. 11 and 12 have substantially smooth surfaces, whereas FIGS. 13 and 14 show panels that do not have substantially smooth surfaces. The contoured surfaces of panels 13 and 14 can have aesthetic features formed therein, such as figures or trademarks; can have features that impart some beneficial feature other than, or in addition to aesthetic features, such as to increase the structural rigidity of an individual panel. Panels 1102, 1202, 1302 and 1402 can be made to any suitable size, and in general panels typically are between 2 inches×2 inches and 12 feet×12 feet although larger and smaller panels are possible. A working design is approximately 12 inches×12 inches. Panels 1102, 1202, 1302 and 1402 need not be substantially square, and other shapes, such as circular, rectangular, etc., also are useful. Panels 1102 and 1302 are solid panels, and have no air or sight holes. As stated, one or more panel surfaces, such as at least a first surface 1104 or 1204 may have a substantially smooth surface, or may have a pattern or texture. Panel 1302 is illustrated as having a raised star and rainbow ridge or topographical design pattern 1306 on the solid surface 1304. Surface pattern, such as pattern 1306, serves to add any desirable “attractive” or “aesthetically pleasing” feature and also may provide some rigidity and strength, especially in molded plastics, for example. Panel 1402 is illustrated as having the same topographical pattern 1406 on surface 1404, but with air or sight holes 1408 in this example.

Panels 1102, 1202, 1302 and 1402 for this example each contain at least one, and perhaps plural, connectors for connecting two or more panels together. Panels 1102, 1202, 1302 and 1304 are illustrated as having two male hinge snaps 1110, 1210, 1310 and 1410 on each of two sides, and two female hinge snaps 1112, 1212, 1312 and 1412 on each of two sides, respectively.

Panels 1102, 1202, 1302 and 1402 can be assembled into multi-dimensional expandable crates, such as crate 1500 of FIG. 15. In the illustrated example of crate 1500, plural solid panels 1502 are assembled to form a roof 1504 and an opposing floor 1506. And, in this exemplary embodiment, the other four sides of crate 1500 are assembled using the panels 1508 with air and sight holes 1510. Assembly involves snapping together the appropriate connectors. For example, panels can be joined to form corner units. Each corner unit has 3 panels and a fully assembled crate has eight corner units.

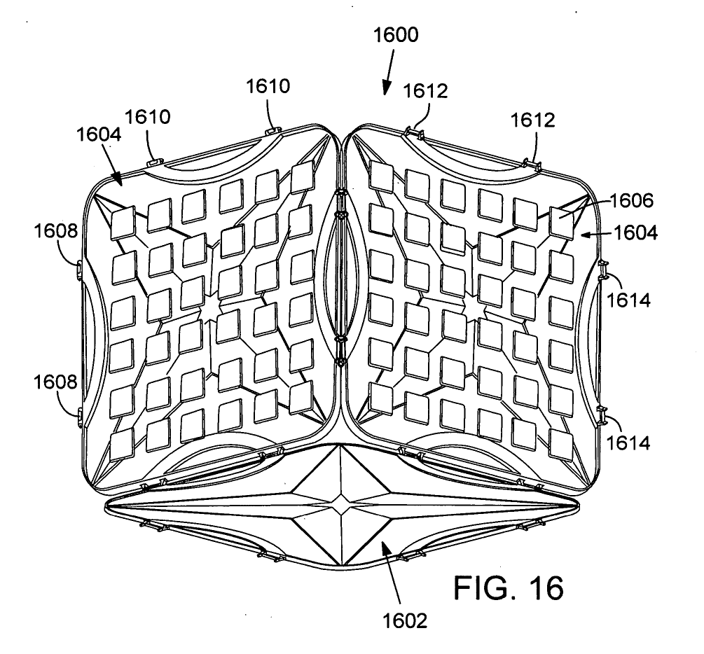

An assembled corner unit 1600 is illustrated in FIG. 16. Corner unit 1600 includes solid panel 1602 and two panels 1604 having air and sight holes 1606. Each panel in this example uses two hinge parts, such as hinge parts 1608, 1610, 1612 and 1614, on each of two sides (a total of four hinge parts connected per panel in this example) in connecting each corner. Fewer or greater numbers of hinge parts can be included and used. Each panel also has two hinge parts on each of two unconnected sides (a total of four hinge parts) that are not used in assembling the corners of this one preferred embodiment. Fewer or greater numbers of hinge parts can be included and unused. Further assembly of corners like corner 1600 of FIG. 16 produces the bottom one-half of the multi-dimensional expandable crate 1500 of FIG. 15 and is analogous to assembly of corners as described and illustrated with reference to FIG. 2. Assembly of the top one-half of the multi-dimensional expandable crate 1500 is analogous to assembly of corners as discussed by flipping over the components illustrated by FIG. 2.

FIG. 15 illustrates an assembled multi-dimensional expandable crate 1500 having one end open 1506 to provide ingress and egress. In this illustration the ingress and egress opening (the “door”) can be opened or closed when crate 1500 is in any degree of expansion or contraction. The illustrate door of crate 1500 includes four panels 1512, 1514, 1516 and 1518, and is expandable/collapsible in at least two dimensions. A further and unexpected benefit of this embodiment is that any side (including the roof and floor) of the assembled crate 1500 can be independently opened and closed from the middle of the side or from either right to left, or left to right, or top to bottom, or bottom to top for any degree of crate expansion. This is illustrated in FIG. 15 as panels 1512 and 1514 are not coupled together and instead are independently movable. Conversely, panels 1516 and 1518 form an integrated unit. Connectors, such as slide guides and locking clips, hold adjacent panels together if the panels are disconnected from snap hinge snaps for opening. Opening from the center only involves removing connectors, such as slide guides and/or locking clips. Opening from the edges only involves grasping the edge desired to be opened using the convenient air holes 1510 and pulling connectors apart along three sides, which leaves the panel hinged to swing on the edge that is still connected. Further, an entire end may be removed if desired, such as by removing panels 1512, 1514, 1516 and 1518, and the remainder of crate 1500 is still expandable and collapsible in multi-dimensions. The top also may be removed or opened. If it is desired that one particular end is to be the primary site of opening and closing the number of hinge connecting points on edges that are opened can be minimized, if desired by omitting panel connectors, such as connecting hinge snaps.

In some cases it is desirable to assemble the panels in a configuration that prevents opening. Airlines, for example, require that pet crates containing pets be “locked” in a secure fashion that prevents accidental opening during travel, especially due to the animal pushing from the inside against the crate sides. It will be readily recognized that certain embodiments of panel connectors, such as the exemplary hinge snaps of panels 1102, 1202, 1302 and 1402 of FIGS. 11-14, can be separated only by moving the solid rod of the male hinge snap in a direction toward the open side of the female hinge snap. It is not possible for the rod of the male hinge snap to pass through the solid side of the female hinge snap. Thus, certain embodiments assemble crates to prevent opening or to make opening difficult for a confined animal. That is, rather than assembling the male and female hinge snaps such that the connected panels can be separated by applying pressure in an outward fashion away from the assembled crate center, the male and female hinge snaps are connected in a fashion that prevents opening in the outward direction away from the center of the crate. As many sides as desired may be assembled this way. Additional steps can be taken to further secure panels from forming a crate opening when not desired, or from being removed from an assembly when not desired. For example, common cable-lock plastic or other suitable ties can be passed though available holes to prevent opening.

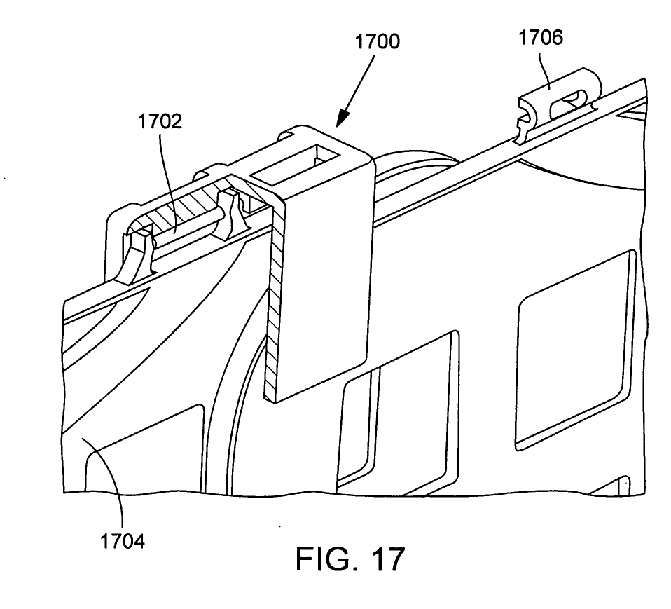

Prior to combining the top one-half and bottom one-half of the multi-dimensional expandable crate 1500, an optional guide clip 1700 as illustrated in FIG. 17 may be snapped onto a hinge part, such as hinge part 1702, not used in the three panel corner assembly. As a result, guide clip 1700 is attached to a panel, such as panel 1704 of one assembled corner. Guide clip 1700 slides freely over an adjacently positioned panel of a different corner assembly. Guide clip 1700 is designed to snap onto a male hinge 1702 in this example. It will be appreciated that other guide clips may be designed to snap onto a female hinge 1706. Still other embodiments are designed to snap into either a male hinge 1702 or a female hinge snap 1706. Guide clips 1700 are designed to fit over one, two, three or more adjacent panels as desired. The purpose and advantage of a guide clip 1700 is to hold adjacent sliding panels in a physical relationship that is conducive to smooth expansion and contraction of the multi-dimensional expandable crate. Guide clip 1700 can act as a “stop” to prevent the crate from being opened beyond the ends of the sides. As few or as many guide clips 1700 as desired may be used. In one embodiment eight guide clips are employed with one on each side of the bottom one-half and one on each side of the top one-half of a multi-dimensional expandable crate. It will be recognized that any suitable guide clip design may be used for the functions described and the example given is not intended to be limiting.

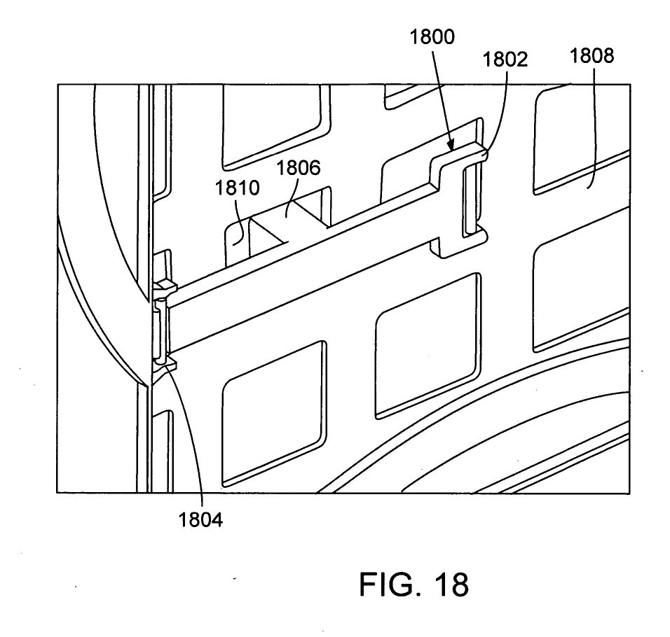

FIG. 18 shows another embodiment of locking clip 1800 designed to lock or fix movement in at least one dimension of the assembled multi-dimensional expandable crate. Once an expandable crate is in a desired degree of expansion it may be desirable to lock the crate to prevent further expansion or collapsing when undesired. The illustrated locking clip 1800 has a first end 1802 and a second end 1804. Locking clip 1800 also has a middle arm 1806. Arm 1806 is useful for a panel 1808 having an air or sight aperture 1810. Arm 1806 extends into aperture 1810 when assembled. Thus, clip 1800 can be secured to a panel 1808, or plural panels, to preclude relative movement. For example, FIG. 18 illustrates using locking clip 1800 to hinder horizontal panel movement. Locking clip 1800 can be reoriented and connected to one or more panels to hinder or preclude vertical movement.

Locking clip 1800 can be placed to prevent crate expansion or collapsing in length, width, or height, in any sequence, as desired. In one case, for only one example, the assembled crate may be in the fully collapsed position. A person may then expand the crate to a desired length, and lock the length dimension by insertion of one or more clips 1800 on one side or opposing sides as desired. The person may then expand the crate to a desired height, and use additional clips or move the first clips to lock crate movement in the dimensions of height and length. Then, the person can expand the crate to the desired width and move the clips or use additional clips to lock the crate into a fixed dimensional size with respect to length, height, and width. Note that any suitable locking mechanism, such as for example telescoping and locking rods, can be used to fix or lock dimensional movement of the crate.

Clip 1800 is one example of a locking clip and typically has sufficient dimensions to penetrate openings in at least 4 or more, as desired, adjacent panels. One skilled in the art will recognize that the dimensions of clip 1800 will be appropriate for the dimensions of the panels and openings involved. In this illustrated embodiment, locking clip 1800 has a female hinge snap at end 1804 and a male hinge snap at end 1802. One end of the locking clip of this example is snapped into an appropriate hinge snap on a panel and then the rod is inserted into openings in the adjacent panels to lock or prevent expansion or collapsing of the crate. As many or as few locking clips are used as are effective for desired locking of crate movement.

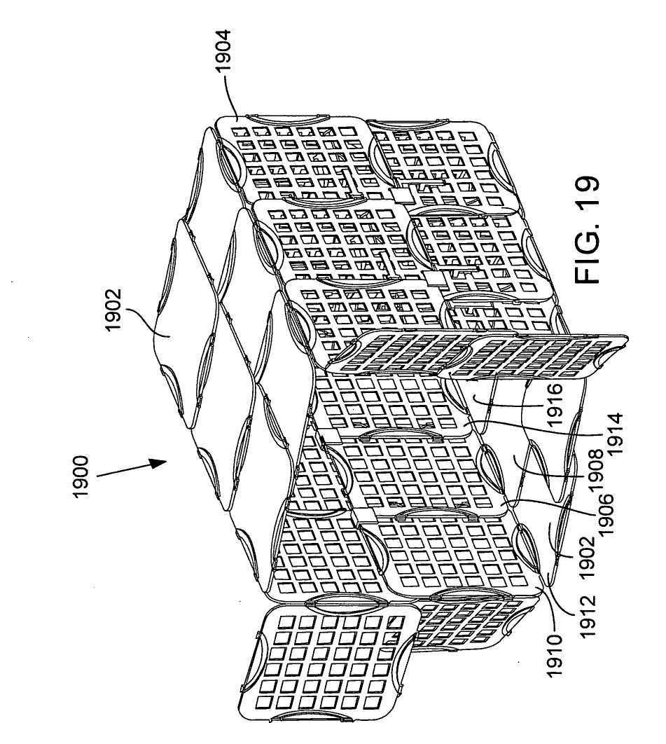

FIG. 19 illustrates a crate 1900 that is assembled using plural panels 1902 and 1904. Crate 1900 includes panels, such as panels 1906 and 1908, that are connected and inserted between panels to provide multiple panels as needed for additional expansion between corner units. Four such connected panels of FIG. 19 are, for example, inserted in between corner units to produce a multi-dimensional expandable crate. One embodiment is essentially square in the assembled collapsed configuration and essentially rectangular in the expanded configuration. Additional panels can be included as desired. It will be readily recognized that the multi-dimensional expandable crate 1900 is ideally suited for use as an animal crate since the crate can be locked into any desired length, width, and height in any sequence and to any degree within the limits of the overall expansion size, which is readily controlled by the number and size of the panels. Thus, the crate can “grow” with the animal, or can be used with a second pet that is larger or smaller than a first pet.

The design of crates 1500 and 1900 as illustrated in FIGS. 15 and 19 are particularly useful as stacking storage modules, such as a closet organizer, which can be adjusted to fit the size of the closet or the size of the materials to be stored. Stacking feet and connections may be included in panels as desired. One-half of the multi-dimensional expandable crate structure, such as the bottom one-half, for example, can be used. One-half of the multi-dimensional expandable crate 1500, such as shown in FIG. 15, or the exemplary crate 1900 of FIG. 19, are expandable and collapsible in two dimensions such as length and width, or width and height, depending on orientation, with a usable interior space in the assembled collapsed configuration, and with sides that open from the middle and swing left or right to provide additional access if desired. This embodiment is, without limitation, useful as a five-sided stacking storage module such as a closet organizer which can be adjusted to fit the size of the closet or the size of the materials to be stored.

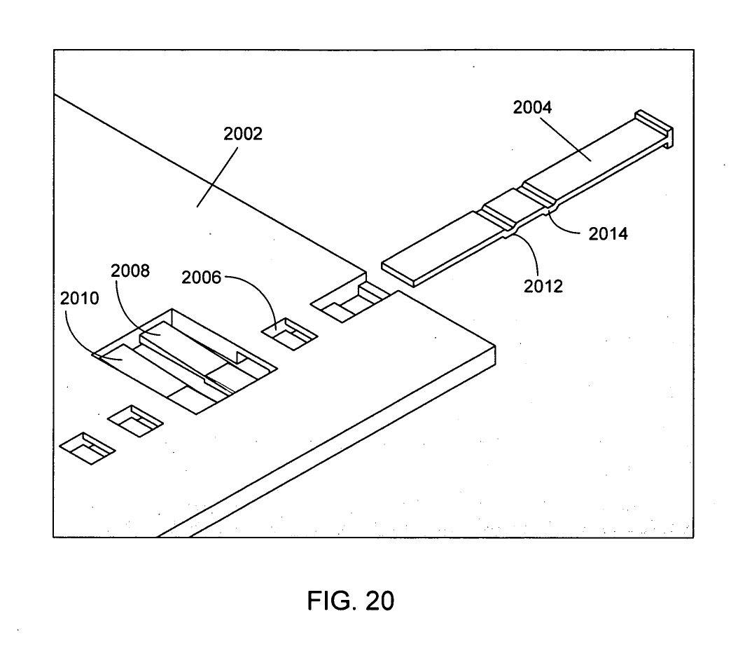

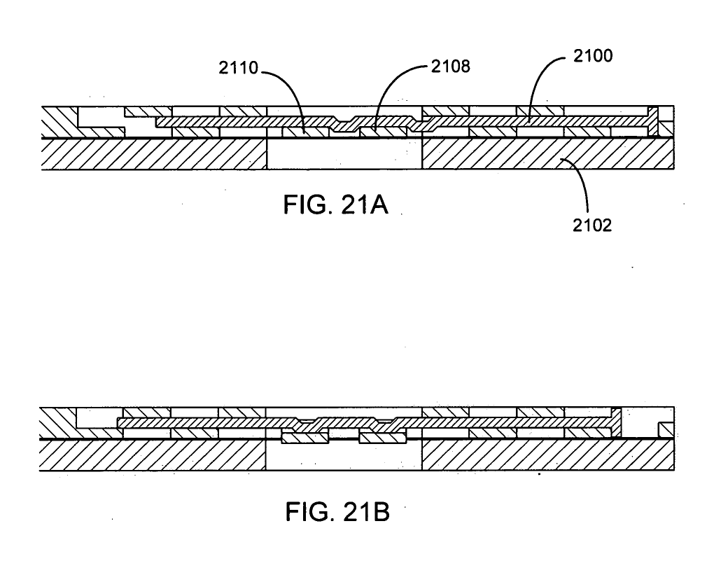

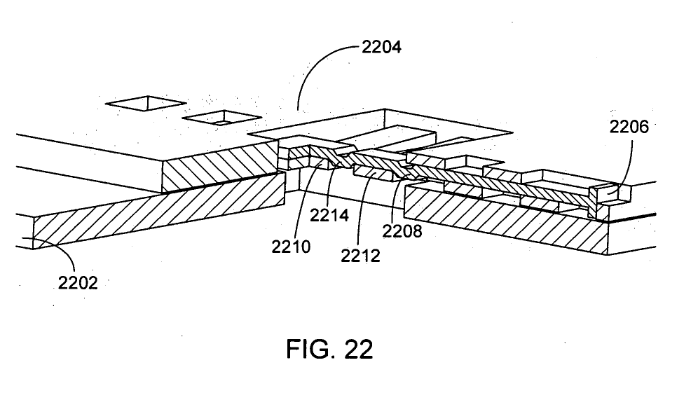

FIGS. 20-22 illustrate an embodiment useful for locking two or more panels relative to one another. For example, FIG. 20 is a perspective view illustrating a panel 2002 having a slide bar 2004. While slide bar 2004 is substantially rectangular, it will be appreciated that other shapes also are useful, such as rods having a substantially circular cross section. Moreover, a person of ordinary skill in the art will appreciate that mechanisms other than that illustrated may be used. For example, some embodiments may include a bar having ratcheting teeth that may be actuated, such as be rotating, to engage openings or stops. Panel 2002 is designed to receive slide bar 2004, as illustrated best in FIGS. 21 and 22. Slide bar 2004 is inserted into a receiving slot sized to receive the bar. Panel 2002 includes plural stops 2006 spaced at intervals along the panel. Furthermore, panel 2002 includes at least one stop levers, with two stop levers being illustrated in FIG. 20. Similarly, slide bar 2004 includes stop teeth 2012 and 2014.

FIG. 21 illustrates slide bar 2100 inserted partially into panel 2102. Stop levers 2108 and 2110 are not actuated in FIG. 21A. As slide bar 2100 is further inserted into panel 2012, as illustrated in FIG. 21B, levers 2108 and 2110 are actuated by stop teeth 2112 and 2114.

FIG. 22 illustrates a first panel 2202 and a second panel 2204 fixed in relative positions to one another using slide bar 2206. Stop teeth 2208 and 2210 of slide bar 2206 have actuated levers 2212 and 2214 to fix panels 2202 and 2204 relative to one another.

Although preferred embodiments have been illustrated in the accompanying drawings and described in the foregoing text, it will be understood that the invention is not limited to the embodiments disclosed which are illustrative only of the principles of the invention but the invention is capable of numerous rearrangements, modifications, and substitutions of parts and elements as will readily occur to those skilled in the art without departing from the spirit of the invention, and accordingly, all such suitable modification and equivalents may be resorted to, falling within the scope of the invention.

I claim:

1. A crate that is expandable in multi-dimensions.

2. The crate according to claim 1 comprising an animal crate that has expandable length, width, and height dimensions and having both a collapsed configuration and an expanded configuration, both the collapsed configuration and the expanded configuration defining a usable interior space.

3. The crate according to claim 2 that can be expanded at least 1.8 times its' original dimension in at least one of the dimensions of length, width, and height.

4. The crate according to claim 1 comprising an animal crate comprising multiple panels of fixed dimensions that assembled together to produce an animal crate expandable in multi-dimensions.

5. The crate according to claim 1 comprising at least 5 sides.

6. The crate according to claim 5 expandable and collapsible in at least two dimensions and defining a usable interior space in an assembled collapsed configuration.

7. The crate according to claim 6 expandable in at least two of length, width, and height.

8. The crate according to claim 5 further comprising at least one openable side to provide ingress/egress.

9. The crate according to claim 1 comprising a five-sided stacking storage module.

10. The crate according to claim 9 comprising a closet organizer.

11. The crate according to claim 1 comprising 6 sides that has expandable length, width, and height dimensions and having both a collapsed configuration and an expanded configuration, both the collapsed configuration and the expanded configuration defining a usable interior space.

12. The crate according to claim 11 that can be expanded at least 1.8 times its' original dimension in each of the dimensions of length, width, and height.

13. The crate according to claim 1 comprising multiple panels of fixed dimensions that assemble together to produce a crate expandable in multi-dimensions.

14. The crate according to claim 1 defining a collapsible/expandable structure both collapsed and expanded structures enclosing usable interior space definable by dimensions of length, width, and height, the structure comprising:
a top roof and bottom floor each expandable/collapsible in at least two dimensions; and
front and rear walls each expandable/collapsible in at least two dimensions;
at least two side walls, each expandable/collapsible in at least two dimensions, the side walls being attached to the roof and to the bottom and to the front and rear walls such that the structure is collapsible/expandable in at least three dimensions.

15. The crate according to claim 14 further comprising an opening for the egress and ingress of an animal.

16. The crate according to claim 14 comprising a door.

17. The crate according claim 16 wherein the door is expandable/collapsible in at least two dimensions.

18. The structure of claim 14 where the sidewalls and front and rear walls are pivotally attached to the floor or roof, or both, to facilitate folding the crate into a configuration that does not have a usable interior space.

19. The crate according to claim 14 comprising a door having at least one panel of fixed dimensions in length, height, and width, where the fixed dimensions for each of length, height and width dimensions can be the same or different.

20. The crate according to claim 19 where the door comprises plural panels that assembled define the door.

21. The crate according to claim 1 having plural side walls, each side wall further comprising at least 4 panels interconnected to allow panel movement to facilitate expanding and collapsing the crate.

22. The crate according to claim 21 where at least two sides further comprise more than 4 panels interconnected to allow panel movement to facilitate expanding and collapsing the crate.

23. The crate according to claim 1 comprising a panel of fixed dimension in length, height, and width constructed to be assembled with other panels of fixed dimension in length, width, and height to produce a vertical or horizontal divider in the crate.

24. The crate according to claim 1 comprising 6 walls movably coupled to one another for assembly into a crate capable of resizing in multi-dimensions.

25. The crate according to claim 24 where at least one wall comprises a button and slide.

26. The crate according to claim 24 where 3 panels are joined to define a corner.

27. The crate according to claim 26 where multiple corners are joined to define a crate.

28. The crate according to claim 27 where at least one wall defined by an assembled crate includes an opening for ingress or egress.

29. The crate according to claim 27 where at least one wall defined by an assembled crate includes at least one aperture.

30. The crate according to claim 29 where at least one wall includes plural apertures.

31. The crate according to claim 27 further comprising at least one feature selected from a handle and rollers.

32. The crate according to claim 1 having least one wall that includes at least one aperture.

33. The crate according to claim 32 where at least one wall includes plural apertures.

34. The crate according to claim 32 further comprising at least handle, rollers, or combinations thereof.

35. The crate according to claim 1 comprising a door having plural panels coupled together and movable to be sized in multi-dimensions, the door further comprising telescoping rods.

36. The crate according to claim 35 where the rods are spring loaded.

37. The crate according to claim 35 where the rods act as hinges.

38. The crate according to claim 1 defining a camping crate for housing at least one individual, the crate comprising plural panels movable in multi-dimensions and sizeable in an assembled state for receiving at least one human.

39. The crate according to claim 38 comprising a portable crate.

40. The crate according to claim 1 comprising at least one component made by extrusion molding, pressure molding, or both.

41. The crate according to claim 1 having plural components made by extrusion molding, pressure molding, or both.

42. The crate according to claim 1 having at least one curved corner.

43. The crate according to claim 42 where the at least one corner is substantially rounded.

44. The crate according to claim 1 having at least one component that can be expanded in multi-dimensions.

45. The crate according to claim 1 comprising multiple panels of fixed dimensions, at least a portion of the panels comprising at least one male hinge snap, at least one female hinge snap, or both, for connecting appropriate female or male hinge snaps of additional panels to form the crate.

46. The crate according to claim 1 comprising at least one slide guide clip.

47. The crate according to claim 1 comprising at least one locking clip.

48. The crate according to claim 1 useful as a camping sleeper, tool shed, a bullet-proof or bullet resistant housing structure or hunting blind.

49. A panel of a fixed dimension in length, height, and width constructed to be assembled with other panels of fixed dimension in length, width, and height to produce a crate expandable in multi-dimensions.

50. The panel according to claim 49 for assembly of an animal crate.

51. The panel of claim 49 where the fixed dimension in length, height, and width of assembly are not equal dimensions

52. The panel according to claim 49 to be assembled with other panels of fixed dimension in length, width, and height to produce a door or closure for an opening in a crate expandable in multi-dimensions.

53. The panel according to claim 49 to be assembled with other panels of fixed dimension in length, width, and height to produce a vertical or horizontal divider in a crate expandable in multi-dimensions.

54. The panel according to claim 49 comprising at least one male hinge snap, at least one female hinge snap, or both, for connecting appropriate female or male hinge snaps of additional panels.

55. The panel according to claim 54 for forming an animal crate.
